(19) United States
(12) Patent Application Publication
(10) Pub. No.: US 2012/0230153 A1
(43) Pub. Date: Sep. 13, 2012

(54) SYSTEMS AND METHODS FOR DISTRIBUTED SENSOR CLUSTERS

(75) Inventors: Marshall Seth Brinn, Newton, MA (US); Stephen D. Milligan, Stow, MA (US)

(73) Assignee: Raytheon BBN Technologies Corp., Cambridge, MA (US)

(21) Appl. No.: 13/041,589

(22) Filed: Mar. 7, 2011

(51) Int. Cl. G01S 3/80

(52) U.S. Cl. 367/127

(57) ABSTRACT

Systems and methods for processing signals received from at least two sources are described. The two sources may each include an array of sensors. The sensor arrays may be spaced apart on the surface of a body, such as an aircraft, a ground vehicle, or a building. The sensors are configured for receiving signals from the at least two sources indicative of timing information. The timing information may be associated with a shockwave of a projectile and a location processor configured for determining shooter location based on signals output by each of the at least two arrays of sensors is coupled to each of the at least two arrays of sensors. The location processor is configured to compute global time metrics and local reference times associated with each of the sensors and determine shooter location based on a relationship between computed global time metrics and local reference times.

### FIELD OF THE INVENTION

This invention relates generally to security systems, and more particularly to systems and methods for using distributed sensor clusters to detect the origin and path of supersonic projectiles fired at a military vehicle. This invention also relates to methods for synchronizing the timing information associated with signals received from at least two sources, each of which may include a cluster of sensors.

### BACKGROUND

With recent developments in weapons technology combined with an evolving face of global terrorism, there has been an increase in the threat posed to military personnel in combat, rescue and humanitarian missions in urban settings (e.g., door-to-door warfare), aircraft (e.g., helicopters) and ground vehicles (e.g., Humvees). For example, terrorist militiamen are using inexpensive, portable and readily available weapons such as sniper rifles and shoulder-fired missiles against ground vehicles, low flying aircraft such as helicopters and airplanes during landing and takeoff, and military personnel taking cover in buildings in an urban setting. In fact, urban warfare has become so widespread in combat zones, that military personnel in these settings are seeing rapid increases in threats from such sniper rifles and shoulder-fired missiles.

It is beneficial for an aircraft, ground vehicle, or even a stationary building in an urban warfare setting to have defense systems for identifying and neutralizing the source of the gunfire. Many current-day systems for determining the location of a shooter include sensors that record acoustic signals generated by the muzzle blast of the firing weapon or by both muzzle blast as well as the shockwave of the projectile. There are also systems that detect shooter locations using only acoustic signals from only the shockwave of the projectile. Such systems typically include an array of closely spaced acoustic sensors. One such system may be implemented in aircraft and is described in commonly-owned U.S. Patent Application Publication Number 20100020643, the contents of which are incorporated herein in their entirety. Another such system may be implemented in ground vehicles or on stationary buildings and the like is described in commonly-owned U.S. Pat. No. 7,359,285, the contents of which are incorporated herein in their entirety.

### SUMMARY OF THE INVENTION

In certain vehicles, however, the location of the sensors is constrained by the configuration of the vehicle—external or internal—itself. For instance, in some aircraft, the wire harnesses that could allow transmission of sensor outputs to the aircraft avionics system are pre-determined and fixed at certain hull mounting points (also referred to as “wiring access points” or “hull access points”) and thus, only traverse certain parts of the aircraft. Furthermore, the communication bandwidth of these wire transmissions is generally limited, further constraining the number of sensors that the aircraft will accommodate. In particular, because of the speed at which a projectile approaches and traverses a sensor affixed on the aircraft, a large number (e.g., 2048 or 4092) samples must be recorded by the sensor and processed by a processor to determine a shooter location. For instance, if the processor is located in the cockpit of the aircraft or in some location that is physically separated from the sensors, which are generally located at or near hull mounting points or wiring access points, and the limited bandwidth (i.e., high-fidelity signal carrying capacity) of the wiring between these two locations, it is difficult to send all the recorded samples for a plurality of sensors to the processor for processing. Buildings or other urban structures may also be constrained in terms of sensor mounting points and/or such bandwidth constraints. In some ground vehicles, too, it is only possible to install acoustic sensors at certain mounting points or wiring access points on the exterior of the vehicle, and bandwidth constraints may play a role in sensor locations, too. Thus, it is not always possible to position the acoustic sensors freely at any point on the exterior of an aircraft, ground vehicle, or building.

Furthermore, when sensors are mounted in different locations, the signals generated by the sensors at each location may not be synchronized. For instance, one set of sensors may generate a signal with respect to a time reference t₁, while another set of sensors may generate a signal with respect to a time reference t₂, where t₁ and t₂ are different. In these cases, there is a need to synchronize the signals and/or the timing information associated with the signals received from the sensors at each location.

Therefore, there exists a need for systems and methods that employ an array of acoustical sensors which can be placed at positions allowed by the surface of a body such as a building, aircraft, or ground vehicle, and yet allow for accurate shooter detection. There also exists a need for methods that allow signals and/or timing information associated with the signals received from at least two sources to be synchronized.

The systems and methods described herein include improved systems and methods for detecting, using distributed sensor clusters mounted on a building, an aircraft, or a ground vehicle, the source of projectiles such as bullets fired towards the clusters. More generally, the sensor clusters may be any source such as a seismic sensor, an active sonar sensor array, or a passive sonar sensor array, without limitation. The systems and methods described herein also provide improved methods for synchronizing the timing information received from at least two such sources. The sources may include one sensor or a cluster of two or more sensors. In particular, by computing local and global time metrics associated with the signals received from the source, the timing information associated with each source may be synchronized. For instance, the timing information received from distributed clusters of seismic sensors which sense seismic activity in the earth's crust may be synchronized to determine propagation characteristics of an earthquake.

In the discussion that follows, embodiments will be described with respect to acoustic sensors that generate shockwave signals that may be processed, e.g., to obtain shooter location information. Those skilled in the art will come to realize that this discussion may be applied to muzzle blast signals generated by acoustic sensors, or more generally, to signals from any source including a suitable sensor such as a seismic sensor, an active sonar sensor array, or a passive sonar sensor array.

In one aspect, the invention relates to a shooter detection system. The system includes at least two arrays of sensors. Each array includes at least two sensors, and the arrays are spaced apart on the surface of a body. The body is one of an aircraft, a ground vehicle, or a building. Each of the sensors is configured for receiving signals indicative of timing information associated with a shockwave of a projectile, such as a bullet. The system also includes a location processor coupled to each of the arrays of sensors configured for unambiguously determining the location of the source of the projectile based on signals output by each of the arrays of sensors. The system also includes an output device in communication with the location processor for outputting the determined shooter location.

In some embodiments, the arrays of sensors are separated by a distance sufficient to unambiguously determine the location with a probability of greater than about 0.8.

In some embodiments, determining the location of the source of the projectile includes computing local Time Differences Of Arrival (TDOAs) associated with each of the at least two arrays of sensors and determining local reference times associated with each of the at least two arrays of sensors. In some embodiments, determining the location of the source of the projectile also includes computing global TDOAs based on local Time Differences Of Arrival (TDOAs) associated with each of the at least two arrays of sensors and local reference times associated with each of the at least two arrays of sensors, and determining the shooter location based on a relationship between the computed global TDOAs. In some embodiments, the relationship comprises a correlation between the global TDOAs. In some embodiments, computing global TDOAs comprises substantially aligning the received signals with respect to the local reference times at each of the at least two arrays of sensors.

In some embodiments, the system includes a first array processor in communication with a first array of sensors of the arrays of the sensors. The first array processor computes local Time Differences Of Arrival (TDOAs) from the signals received at the first array of sensors, and transmits the computed local TDOAs associated with the first array of sensors to the location processor for use in determining the shooter location.

In some embodiments, the system includes a second array processor in communication with a second array of sensors of the arrays of the sensors. The second array processor computes local Time Differences Of Arrival (TDOAs) from the signals received at the second array of sensors, and transmits the computed local TDOAs associated with the second array of sensors to the location processor for use in determining the shooter location.

In some embodiments, the clocks in each of the array processors may be synchronized such that each of the array processors have clock times that are relative to a global reference time. In this manner, the location processor calculates global TDOAs based on array processor local reference times and local TDOAs that are relative to a global reference time, and thus synchronized with one another.

In some embodiments, each array of sensors includes at least two sensors mounted to a sensor mount, and wherein the sensor mount is attached to the surface of the body. In some embodiments, the sensor mount includes an array processor.

In another aspect, the invention relates to a method for locating a shooter of a projectile fired at a body. The method includes receiving, from at least two arrays of sensors mounted on the surface of the body, signals indicative of timing information associated with a shockwave of a projectile fired at the body. The body may be an aircraft, building, or a ground vehicle. Each array includes at least two sensors. The method further includes analyzing the signals received at the at least two arrays of sensors to unambiguously determine a location of the shooter of the projectile. Analyzing the signals includes computing, by a location processor, global Time Differences Of Arrival (TDOAs) associated with each of the arrays of sensors and local reference times associated with each of the arrays of sensors. Analyzing the signals further includes determining, by the location processor, the shooter location based on a relationship between the computed global TDOAs. Analyzing the signals further includes outputting, by the location processor, the location of the shooter to an output device.

In some embodiments, analyzing the signals includes computing, by the location processor, local Time Differences Of Arrival (TDOAs) associated with each of the at least two arrays of sensors, and determining, by the location processor, local reference times associated with each of the at least two arrays of sensors. In some embodiments, computing global TDOAs is based at least in part on the computed local Time Differences Of Arrival (TDOAs). In some embodiments, the relationship comprises a correlation between the global TDOAs. In some embodiments, computing global TDOAs comprises the location processor substantially aligning the received signals with respect to the local reference times at each of the arrays of sensors.

In some embodiments, analyzing the signals further includes computing, by a first array processor in communication with the sensors in a first array of sensors of the at least two arrays of the sensors and the location processor, local Time Differences Of Arrival (TDOAs) of shockwave signals detected by the sensors in the first array of sensors, and transmitting, by the first array processor, the computed local TDOAs associated with the first array of sensors to the location processor for use in determining the shooter location.

In some embodiments, analyzing the signals further includes computing, by a second array processor in communication with the sensors in a second array of sensors of the at least two arrays of the sensors and the location processor, local Time Differences Of Arrival (TDOAs) of shockwave signals detected by the sensors in the second array of sensors, and transmitting, by the second array processor, the computed local TDOAs associated with the second array of sensors to the location processor for use in determining the shooter location.

In a third aspect, the invention relates to a non-transitory computer readable medium including computer readable instructions which, when executed by a processor, cause the processor to perform a method. The method includes the steps of receiving signals indicative of timing information associated with a shockwave of a projectile fired at the body from at least two arrays of sensors mounted on the surface of a body. The body may be an aircraft, a ground vehicle, or a building. Each array includes at least two sensors. The method further includes computing global Time Differences Of Arrival (TDOAs) associated with each of the arrays of sensors and local reference times associated with each of the arrays of sensors. The method further includes determining the shooter location based on a relationship between the computed global TDOAs. The method further includes outputting the location of the shooter to an output device.

In some embodiments, the method further includes computing local Time Differences Of Arrival (TDOAs) associated with each of the arrays of sensors, and determining local reference times associated with each of the arrays of sensors. In some embodiments, computing global TDOAs is based at least in part on the computed local TDOAs. In some embodiments, the relationship comprises a correlation between the global TDOAs. In some embodiments, computing global TDOAs comprises substantially aligning the received signals with respect to the local reference times at each of the at least two arrays of sensors.

In another aspect, the invention relates to a method for synchronizing timing information associated with signals received from at least two sources. The method includes receiving signals indicative of timing information from the at least two sources. The method further includes computing global time metrics and local reference times associated with each of the at least two sources and determining a relationship between the computed global time metrics. Each of the sources includes one of an acoustic sensor, a seismic sensor, an array of passive sonar sensors, and an array of active sonar sensors.

In some embodiments, the method further includes computing local time metrics associated with each of the at least two sources. In some embodiments, the method further includes determining local reference times associated with each of the at least two sources. In some embodiments, global time metrics are computed based at least in part on the computed local time metrics.

In some embodiments, the relationship comprises a correlation between the global time metrics. In some embodiments, computing global time metrics comprises substantially aligning the received signals with respect to the local reference times at each of the at least two sources. In some embodiments, the at least two sources each include at least one array of sensors. In some embodiments, the global time metrics include global Time Differences of Arrival (TDOAs). In some embodiments, the local time metrics include local Time Differences of Arrival (TDOAs). In some embodiments, the timing information is associated with the shockwave of a projectile. In some embodiments, the timing information is associated with the muzzle blast of a projectile.

### BRIEF DESCRIPTION OF THE DRAWINGS

The following figures depict certain illustrative embodiments of the invention in which like reference numerals refer to like elements. These depicted embodiments may not be drawn to scale and are to be understood as illustrative of the invention and as not limiting in any way:

FIG. 1 is a block diagram depicting a detection system on an aircraft for detecting a shooter location, according to an illustrative embodiment of the invention;

FIG. 2 depicts schematically the ambiguity inherent in detection systems utilizing only shockwave information from an incoming projectile;

FIG. 3 depicts the zone below an aircraft where there is a possibility of ambiguity in detecting a shooter location;

FIG. 4 depicts the probability of correctly disambiguating between shooter trajectories;

FIGS. 5A, 5B and 5C depict bottom, left side, and right side views, respectively, of an aircraft having a plurality of arrays of sensors disposed on the fuselage, according to an illustrative embodiment of the invention;

FIGS. 6A and 6B depict top and side views, respectively, of an array of acoustic sensors suitable for placement on an aircraft, ground vehicle, or building according to an illustrative embodiment of the invention;

FIG. 7 is a schematic for a process flow for detecting a shooter's location using information received by at least two arrays of acoustic sensors, according to an illustrative embodiment of the invention;

FIG. 8 shows a block diagram for a method for detecting a shooter's location using information received by at least two arrays of acoustic sensors, according to an illustrative embodiment of the invention;

FIG. 9A is a block diagram depicting the physical components of a computer system, according to an illustrative embodiment of the invention;

FIG. 9B is a more detailed block diagram depicting the physical components of the computer system of FIG. 9A, according to an illustrative embodiment of the invention; and

FIGS. 10A and 10B show a ground vehicle and two buildings, respectively, each with arrays of sensors attached thereto, according to illustrative embodiments of the invention.

### DETAILED DESCRIPTION OF THE ILLUSTRATED EMBODIMENTS

To provide an overall understanding of the invention, certain illustrative embodiments will now be described, including display apparatus and constituent components thereof. However, it will be understood by one of ordinary skill in the art that the apparatus described herein may be adapted and modified as is appropriate for the application being addressed and that the systems and methods described herein may be employed in other suitable applications, and that such other additions and modifications will not depart from the scope hereof.

In this application, embodiments will be described primarily in terms of sensors mounted to the exterior of an aircraft such as a helicopter, however, it will be apparent to those skilled in the art that the systems and methods described herein may also be used in ground vehicle or building applications. Those skilled in the art will come to realize that the synchronization of the timing information described herein with respect to sensors mounted on an aircraft has applications beyond detection systems. In alternative embodiments, the sensors may be of any suitable type, e.g., seismic sensors, acoustic sensors, active sonar sensor arrays, or passive sonar sensor arrays, and the signals may be received from homogeneous clusters of sensors. The signals generated by these homogenous clusters of sensors may be processed to determine useful information. For instance, in a seismic activity detection system, the timing information received from distributed clusters of seismic sensors which sense seismic activity may be synchronized to determine and/or predict the propagation characteristics of an earthquake.

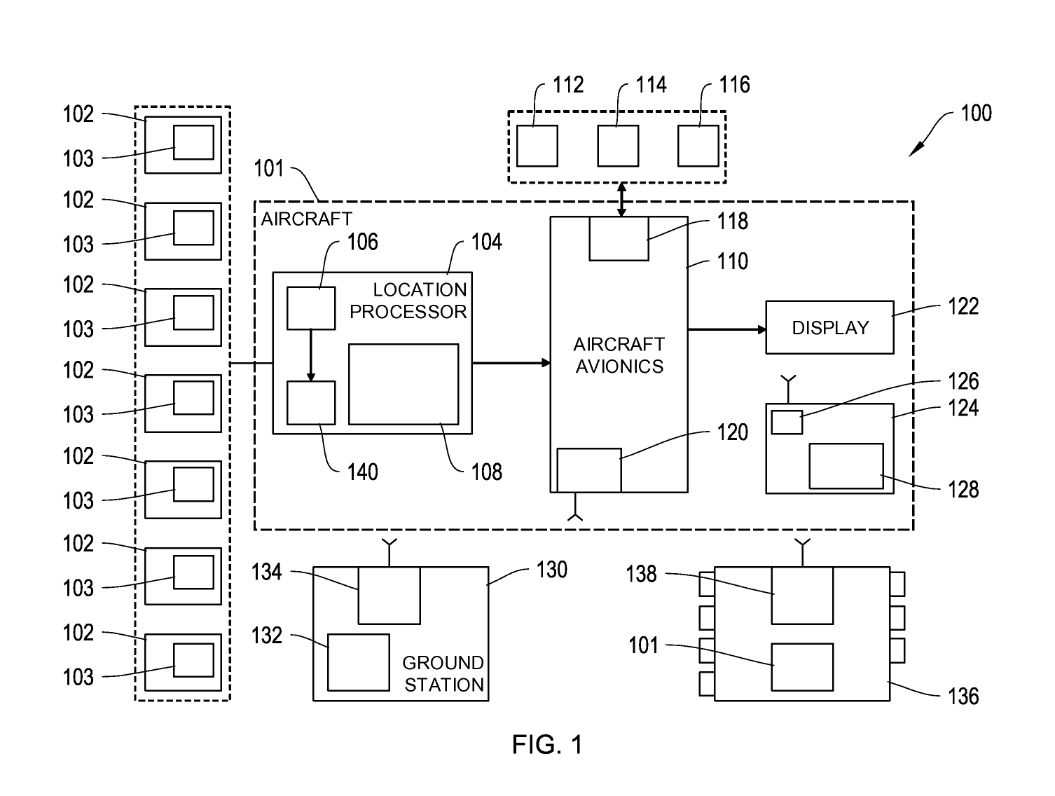

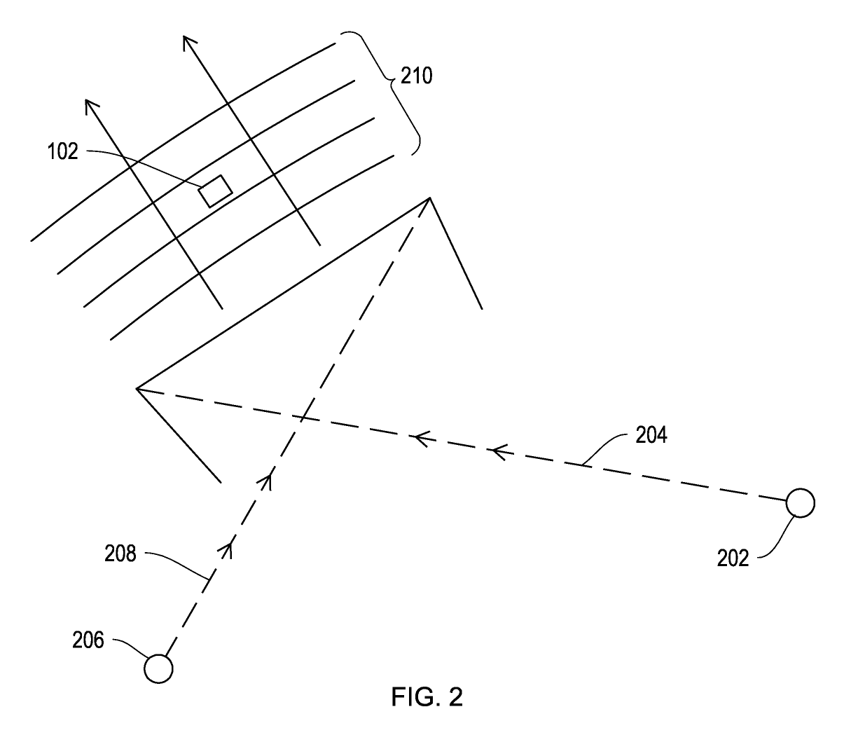

As will be seen from the following description, in one aspect, the systems and methods described herein relate to a detection system having a plurality of sensor arrays distributed (also referred to as “distributed sensor clusters”) across a body of an aircraft such as a helicopter, a ground vehicle such as a Humvee, or a building. The sensor arrays are configured and arranged to receive signals that may be used to unambiguously identify the location of a shooter. Unambiguous identification of shooter location is defined in more detail with respect to FIGS. 1-4, particularly with respect to FIG. 2.

FIG. 1 is a block diagram depicting a detection system 100 for detecting a shooter location on an aircraft 101, according to an illustrative embodiment of the invention. The detection system 100 includes a plurality of acoustic sensor arrays 102 disposed on the body of an aircraft 101. Each of the acoustic sensor arrays 102 includes at least two acoustic sensors. In some embodiments, each of the sensors in the sensor arrays 102 are connected to a location processor 104 and aircraft avionics 110 that may be located inside the body of the aircraft 101. The location processor 104 includes various functional applications and/or hardware subcomponents for managing the sensor arrays 102 and processing data from the sensors in the sensor arrays 102. Some functional applications include a sensor calibration and control application 106 for operating the sensor arrays 102 and receiving data from them, and a shooter location application 108 for calculating the location of a shooter. The location processor 104 further includes a data transport/ conversion/ aggregation component 140 for aggregating the sensor data, converting the data to a suitable format and transmitting the data to the shooter location application 108. The aircraft avionics 110 includes a plurality of electronic circuitry and processors for managing, controlling and operating various features of the aircraft. The aircraft avionics 110 includes, among other things, communication circuitry 120 to communicate with a ground station 130 or with other aircraft 136. The avionics 110 also includes an environmental sensor control unit 118 for operating and collecting data from one or more environmental sensors 112, 114 and 116. In certain embodiments, sensors 112, 114, 116 may be interfaced directly with the location processor 104. The environmental sensors, including temperature sensors 112, aircraft attitude, vector velocity sensors 114 and other sensors 116 such as Mean Sea Level (MSL) and/or Above Ground Level (AGL) altimeters, Global Positioning System (GPS) units and ground velocity sensors are disposed on the external surface of the aircraft fuselage and/or internally.

In some embodiments, each sensor array 102 may also include a sensor array processor 103. In these embodiments, each of the sensor array processors 103 are connected to the location processor 104, and the sensor array processors 103 include various functional applications and/or hardware subcomponents for managing the sensor arrays 102 and processing data from the sensors in the sensor arrays 102. In these embodiments, some functional applications include a sensor calibration and control application 106 for operating the respective sensor array 102 and receiving data from the sensors in the respective sensor array 102, and a sensor array shooter location application for calculating the location of a shooter and/or determining outputs to transmit to the location processor 104 for use in determining the location of a shooter using shooter location application 108. In these embodiments, sensors 112, 114, 116 may be interfaced directly with the sensor array processors 103.

The avionics 110 is connected to the aircraft's heads-up display 122 for displaying, among other things, relevant shooter location information to the pilot. The avionics 110 may also be remotely connected to the pilot's helmet electronics 124, including a helmet display 128, through the helmet communication circuitry 126. The avionics 110 also communicates with one or more ground stations 130. In certain embodiments, the avionics 110 communicates information about shot detection or shooter location to the pilot via audio/intercom announcements. The avionics 110 may also assist the location processor 104 in determining a shooter location by providing relevant data collected from sensors 112, 114 and 116 and other information obtained from the ground station 130, the ground station detection system 132, another aircraft 136 or from the pilot.

When a projectile such as a bullet, traveling at supersonic speed, approaches the detection system 100, the projectile generates an acoustic shockwave. The shockwave surface is typically an expanding conical surface having its axis coincident with the bullet trajectory. The shockwave surface is also referred to as the Mach cone. To resolve the location of the shooter, the arrival angle, the radius of curvature, and the spatial gradient of the radius of curvature of the expanding conical surface are determined from arrival times measured at two or more of the sensors across the plurality of sensor arrays 102.

In one embodiment, during operation, the sensors within each sensor array 102, whose airframe coordinates (positions on the hull mounting points or on the fuselage) are accurately known, receive one or more acoustic signals representative of the shockwave generated by a bullet or other projectile. While the discussion that follows describes embodiments with respect to a shockwave, as described earlier, the description that follows is applicable to received muzzle blast signals and synchronizing the timing information associated with these signals. In particular, in addition to the acoustic shockwave or as an alternative for the generated shockwave, the projectile may also generate a muzzle blast which may be processed using the systems and methods described herein. Across the plurality of sensor arrays 102, at least five, and preferably seven sensors receive the shockwave signal at different times and generate electrical signals in response to the shockwave pressure. For instance, three sensor arrays each with three sensors may receive the shockwave signal. The shooter location application 108 in the processor 104 determines (1) a local Time-Difference-Of-Arrival (TDOA) from the received shockwave signals at each sensor array 102 and (2) a local reference time for each of the local TDOAs. In some embodiments, the local reference time is the local absolute time value at which the shockwave signal reached the first sensor within a sensor array 102.

The shooter location application 108 determines local TDOAs at each sensor array 102 by designating a sensor that first encounters the shockwave as a reference sensor and recording the time that this sensor first encounters the shockwave as a local reference time for the sensor array. The shooter location application 108 then determines the times of arrival of the shockwave at the other sensors in relation to the reference sensor and the local reference time. Based in part on the received local TDOA information, local reference time information, and the airframe coordinates of the sensor arrays 102, the shooter location application 108 on the location processor 104 determines a set of global TDOAs. This set of global TDOAs is used as inputs into a ballistic model to obtain the direction (azimuth and elevation angle) of the origin of the projectile fired at aircraft 101. A more detailed description of the process for determining shooter location based at least in part on TDOA information is provided in commonly assigned U.S. Pat. No. 7,126,877, incorporated herein by reference in its entirety. The shooter location application 108 in location processor 104 may be created and implemented in the processor 104 using hardware circuitry or using software languages including, but not limited to, C, C++, JAVA.

In some embodiments, a shooter location application running on each of the sensor array processors 103 determines (1) a local Time-Difference-Of-Arrival (TDOA) from the received shockwave signals at each sensor array 102 and (2) a local reference time for each of the local TDOAs. In these embodiments, the clocks in each of the array processors 103 are synchronized, i.e., each of the clocks in each of the arrays processors 103 includes a clock time that is relative to a global reference time. This global reference time may be the clock time that is employed by location processor 104. In this manner, location processor 104 later performs computations, e.g., for global TDOAs, based on local reference times and local TDOAs that are relative to this global reference time. In these embodiments, the shooter location application running on each of the sensor arrays processors 103 determines local TDOAs at each sensor array 102 by designating a sensor that first encounters the shockwave as a reference sensor and recording the time that this sensor first encounters the shockwave as a local reference time for the sensor array. The shooter location application running on each of the sensor arrays processors 103 then determines the times of arrival of the shockwave at the other sensors in relation to the local reference time for the sensor array 102. This local TDOA information and/or local reference time information and/or the airframe coordinates of the sensor arrays 102 are transmitted by each of the sensor array processors 103 to location processor 104, which, based at least in part on this received information, determines a set of global TDOAs. The shooter location application running on each of array processors 103 may be created and implemented in the respective array processor 103 using hardware circuitry or using software languages including, but not limited to, C, C++, JAVA.

In certain situations, solving for the arrival angle, relative to the airframe, of the conical surface that first reaches the sensors within each of the sensor arrays 102 may result in two possible solutions (often called “ambiguous” angles). The “ambiguous” angles will be described in more detail below with reference to FIG. 2. As used herein, the term “unambiguous” with respect to a shooter location or a projectile trajectory shall mean the ambiguity with respect to the two possible sources of the projectile has been adequately resolved to determine a single solution. This solution may not be precise and may have a margin of error. Thus, those skilled in the art will realize that “ambiguous” solutions refers to these two possible solutions for a ballistic model, prior to disambiguation, and does not refer to the accuracy of the unambiguous solution, once it is determined. The radius of curvature of the conical surface at the sensors within the sensor arrays 102 may determine both distance and direction to the trajectory. The ambiguity between the two possible solutions can be removed by determining and evaluating the gradient of the radius of curvature of the cone.

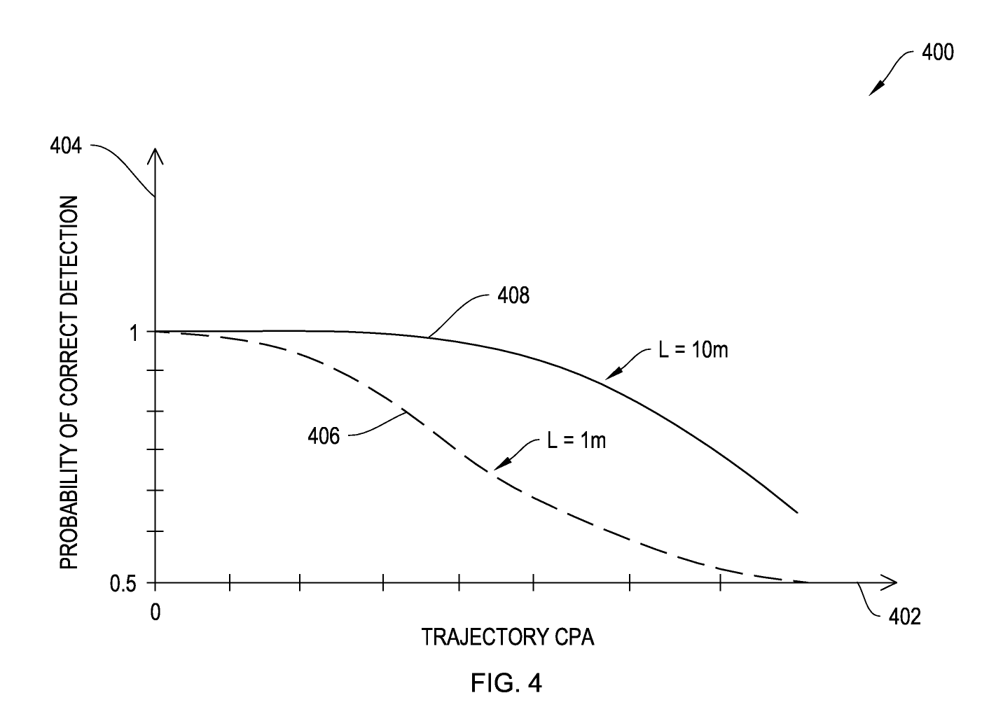

Determining these shockwave properties (the arrival angle, the radius of curvature, and the spatial gradient of the radius of curvature of the expanding conical surface) accurately, and deciding between the two possible “ambiguous” trajectory angles requires very precise measurements. For example, random errors should be no greater than the ones depicted on FIG. 4 to decide correctly between the two alternative shooter aspect angles. The required accuracy can be estimated by considering the propagation characteristic of the shockwave. In certain embodiments, the arrival time of the shockwave is measured to within 0.1 percent of the difference in travel times between the farthest sensor arrays 102. Moreover, shockwaves reaching the fuselage of the aircraft, in general, pass through intense turbulence that has the effect of smearing in time the leading edge of a shockwave generated by a projectile by up to approximately 30 microseconds. The detection system 100 preferably includes a sufficient number of sensor arrays 102 strategically placed on allowable locations (e.g., hull mounting points) on the surface of the body of the aircraft 101 such that most, if not all, shockwaves resulting in potentially ambiguous location solutions are detected by at least five (5) sensors across the plurality of sensor arrays 102. Five (5) sensors across the plurality of sensor arrays 102 at a minimum are used for resolving, unambiguously, the location of a shooter. Using information from a sixth sensor from one of the plurality of sensor arrays 102 provides a more accurate estimate of the location of the shooter.

FIG. 2 depicts schematically the ambiguity inherent in detection systems utilizing only shockwave information from an incoming projectile. For a given shooter position 202 and bullet trajectory 204, there is another shooter position 206 and bullet trajectory 208 for which the time of arrival of the shockwave at a given set of sensors is nearly identical. The two ambiguous solutions are substantially identical and thus cannot be disambiguated if in a simplified model, the shockwave 210 is assumed to propagate across the sensors in the sensor array(s) 102 as a plane wave. If the TDOA resolution is high enough to resolve the curvature of the shockwave, then the two nearly identical solutions can be disambiguated. Assuming sufficiently accurate TDOA measurements, the location processor 104, optionally in conjunction with an array processor 103, may obtain the gradient of the curvature and thereby obtain the true solution for shooter position and bullet trajectory by computing the shooter/trajectory combination that minimizes the root-mean-square (RMS) residual of measured and computed shockwave TDOA.

With reference to FIG. 1, an aircraft may have a plurality of sensor arrays 102 strategically positioned around its fuselage. Ambiguity in determining shooter location may exist all around the aircraft because as noted earlier, for every shooter location, there exists another shooter location (mirror image) that may be able to account for the shockwave received at the sensors. Depending on the trajectory of the projectile with respect to the aircraft as well as the aircraft's orientation with respect to ground level, the mirror image may be non-terrestrial. For the purposes of detecting ground based shooters, particularly in applications in which sensor arrays are mounted on aircraft, the solutions corresponding to non-terrestrial shooter locations are disregarded leaving only one ‘true’ solution.

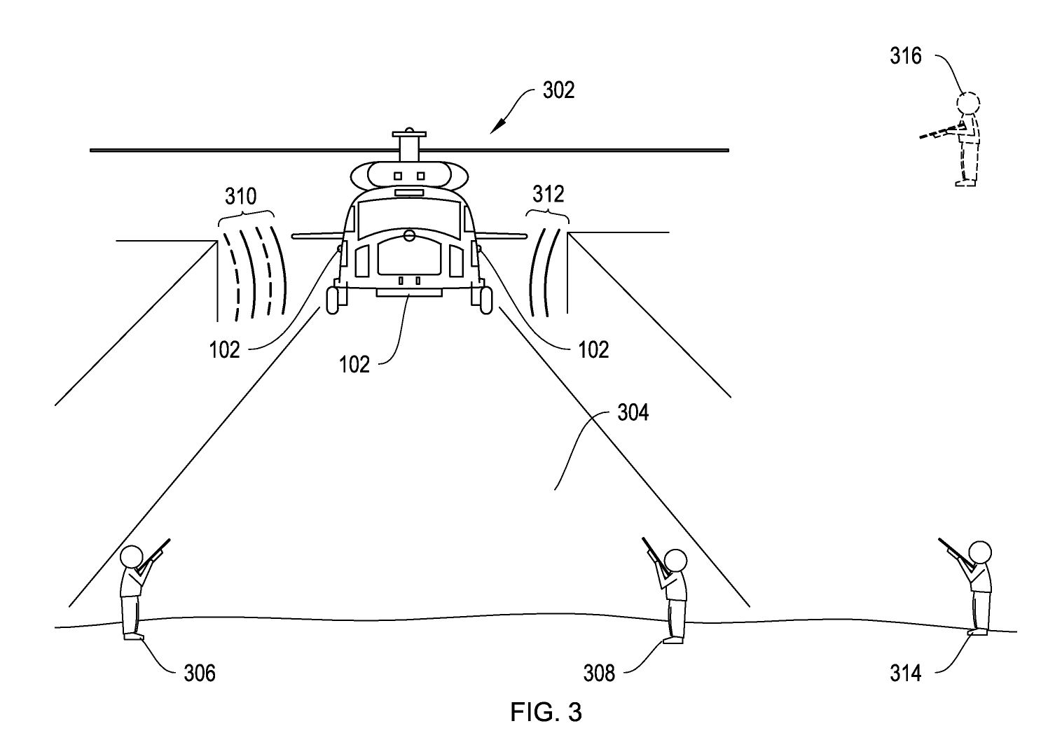

However, as shown in FIG. 3, when the a shooter is positioned underneath an aircraft and missing projectiles pass below the aircraft 302 fuselage (missing low), the mirror images may also be terrestrial. That is, there are two possible terrestrial shooter locations. In particular, FIG. 3 depicts the zone 304 below an aircraft 302 where there is a possibility of ambiguity in detecting a shooter location. For simplifying this discussion, assume that the aircraft 302 is level with ground. Under this simplifying assumption, shooter 306 is located in a zone 304 underneath the aircraft fuselage. Consequently, when missing projectiles fly below the aircraft, their corresponding shockwaves strike the bottom of the aircraft's fuselage, but not the side of the fuselage.

Generally, when a shooter 314 is located outside zone 304, portions of the shockwave generated by missing projectiles, passing above (missing high) or below (missing low) the aircraft, strike the sensor arrays 102 located on the right or left of the aircraft, and potentially sensor arrays 102 on the bottom, as well. In such a situation, the mirror image 316 of the shockwave striking the side sensor arrays 102 is non-terrestrial. Therefore, as described above, the system 100 may be able to unambiguously and readily identify the location of the shooter 314 as being the shockwave originating from the projectile fired from the terrestrial location. When a shooter 306 is located within zone 304 and the projectile fired by the shooter 306 misses high, portions of the shockwave strike the sensor arrays 102 located on the right or left of the aircraft. Therefore, similarly, depending on which sensors within which sensor arrays receive these shockwaves, the system 100 may be able to unambiguously and readily identify the location of the shooter.

However, when a shooter 306 is located within zone 304 and the projectile fired by the shooter 306 misses low, the shockwave-only detection system may require additional data to identify the location of shooter 306 and distinguish it from its ambiguous mirror image location 308. In certain embodiments, the system 100 includes at least five (5), six (6), seven (7), or more sensors within the plurality of sensor arrays 102 that receive acoustic shockwaves coming from projectiles missing low fired by shooters located within zone 304. These sensors may be positioned on the bottom of the fuselage of the aircraft 302. The system 100 may unambiguously identify the location of the shooter by resolving the curvature of the shockwave.

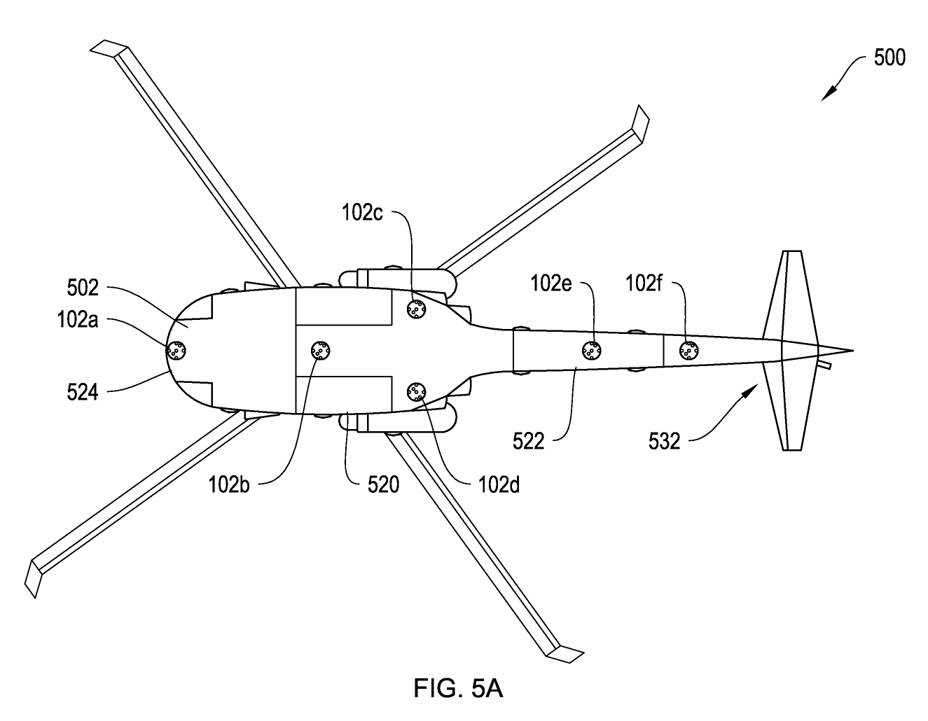

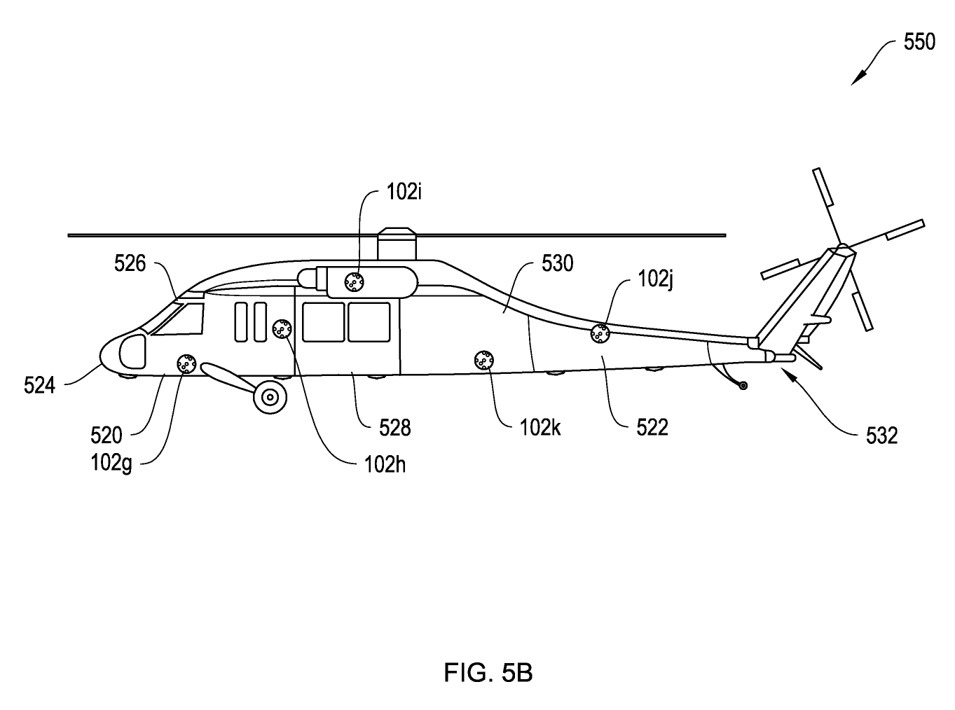

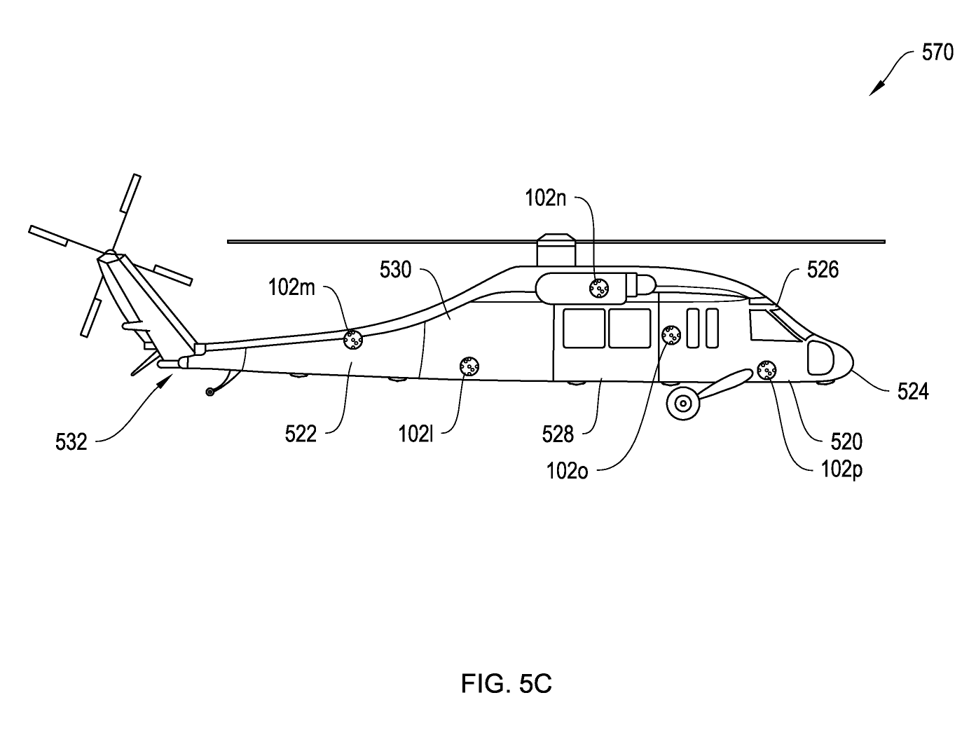

Aircraft, however frequently alter their orientation during flight, e.g., banking while turning. For example, during flight, an aircraft may be required to tilt from one side to another, or raise or lower its nose. During such maneuvers, the left, right, front or back of the aircraft may be exposed to the ambiguity zone 304. Consequently, the system 100 may be configured such that at least five (5), six (6), seven (7) or more sensors across the plurality of sensor arrays 102 spaced apart on the aircraft receive acoustic shockwaves regardless of the orientation of the aircraft. In certain scenarios, zone 304 may be located above, below or on any side of the aircraft depending on the location of the ambiguous shooter (e.g., flying through a canyon). Generally, when the missing projectiles fly above the aircraft 302 (miss high), the location of shooter 306 can be disambiguated and resolved because location solutions derived from the shockwaves 310 and 312 will result in only one possible terrestrial shooter location. In certain embodiments, the system 100 includes as many sensors as necessary such that at least five (5), six (6), seven (7), or any number of sensor arrays spaced across the aircraft are available to receive shockwaves from any angle and/or when the aircraft is tilted in any direction. As will be discussed with respect to FIGS. 5A-C below, physical constraints limit the placement of sensor arrays, and thus, system 100 includes as many sensors as possible within these constraints.

Traditional techniques of disambiguating shooter locations using muzzle blast signals while applicable to ground vehicles and buildings, are inapplicable in an aircraft such as a helicopter because the frequency range of muzzle blast signals overlaps the frequency range of acoustic noise on a helicopter. Therefore, the acoustic noise on the body of the helicopter tends to drown out signals from muzzle blasts. For shockwave caused by projectiles having two potential trajectories originating from the ground, system 100, instead estimates the gradient of the radius of curvature of the shockwave along the path of the surface which in turn determines which direction the bullet is moving, thereby removing the ‘ambiguity’ between the two possible directions. However, to estimate the gradient of curvature with a sufficiently high probability, at least two sensor arrays 102 are separated by a distance sufficient to resolve the curvature of the shockwave.

Not to be bound by theory, but the further apart the sensor arrays 102 are, the higher the probability of correctly disambiguating the location of a shooter based on the shockwave from a missing projectile. FIG. 4 depicts the probability of correctly disambiguating between shooter trajectories. Referring now to FIG. 4, the probability of a correct decision, or confidence level for disambiguation, is plotted for two exemplary sensor array 102 spacings, L=1 m and L=10 m, where L is the approximate distance between the centroid (i.e., the geometric center) of a sensor array 102, against the closest point of approach (CPA) between the projectile's trajectory and the centroid of one or more sensors across the plurality of sensor arrays 102. In particular, the horizontal axis 402 is the closest distance between a projectile's trajectory and the system 100, namely the CPA. The vertical axis 404 shows the probability of a correct decision. The curve 406 shows the probability of a correct detection values for a range of CPAs when the sensor arrays 102 are placed about 1 m from each other. The curve 408 shows the probability of a correct detection values for a range of CPAs when the sensor arrays 102 are placed about 10 m from each other. It is evident that a larger sensor array spacing has significantly expanded range for unambiguous solutions. For large CPA values, the difference in curvature at the two sensor arrays 102 is greater when the sensor array spacings are greater than or equal to about 10 m. Consequently, the probability of a correct detection or disambiguation at these large CPA values is higher when the sensor array spacing is greater than or equal to about 10 m. As noted earlier, such a sensor array arrangement is advantageous because, among other things, high CPA values are common when portable weapons such as sniper rifles are fired at aircraft through intensely turbulent rotor or wing downwash. In certain embodiments, the sensor array spacing depends on, among other things, a desired confidence level for disambiguation. In such embodiments, for a given CPA value, the sensor array spacing may be less than or greater than 10 m to achieve a desired level of confidence. The largest sensor array spacing (largest of the distances between the centroids of at least two sensor arrays 102 in the system 100) may be from about 8 m to about 11 m. In such embodiments, the remaining sensor arrays 102 of the system 100 may be spaced apart by any distance. In certain embodiments, the spacing between at least two sensor arrays is greater than 11 m.

FIGS. 5A, 5B and 5C depict bottom, left side, and right side views, respectively, of a helicopter having a plurality of arrays of sensor arrays disposed on the fuselage at allowable hull mounting points, according to an illustrative embodiment of the invention. In the embodiment of FIGS. 5A-C, the helicopter 520 include a total of sixteen (16) sensor arrays including five (5) on each of the right side 550 and left side 570 and six (6) on the bottom 500. As described above, at least five sensors across a plurality of sensor arrays are required to determine an unambiguous shooter location. Thus, at least two (2) sensor arrays, each with three sensors, would satisfy the requirement of having at least five sensors across a plurality of sensor arrays for determining an unambiguous shooter location. More often, however, due to the frequency of aircraft movement, not every sensor in a sensor array will receive a shockwave signal. Furthermore, if the desired confidence level for disambiguation described above with respect to FIG. 4 is high, then the sensor arrays need to be spaced further apart on the aircraft. Given these two constraints, more often three (3) sensor arrays spaced apart on each side and bottom of the aircraft, i.e., a total of nine (9) sensor arrays on the aircraft, would be employed to determine an unambiguous shooter location. Thus, the embodiment of FIGS. 5A-C is merely illustrative in terms of the number of sensor arrays placed on the helicopter. As described above, in addition to being influenced by certain mathematical constraints as described above, sensor array placement may also be constrained by the internal and external physical structure of the aircraft 101. Theoretically, it would be preferable to place sensor arrays 102 substantially equally apart on the body of the aircraft, thereby providing a uniformly distributed system 100. However, such an arrangement may be difficult to achieve because of the physical constraints imposed by the wiring access points, available space, and the communication bandwidth constraints on aircrafts. For instance, in some aircraft, the wire harnesses that could allow transmission of sensor outputs to the aircraft avionics system are pre-determined and fixed at certain wiring access or hull access points, and thus, only traverse certain parts of the aircraft. Furthermore, the communication bandwidth of these wire transmissions is generally limited, further constraining the number of sensors that the aircraft will accommodate. In particular, because of the speed at which a projectile approaches and traverses a sensor affixed on the aircraft, a large number (e.g., 2048 or 4092) samples must be recorded by the sensor and processed by a processor to determine the shooter location. As the processor is generally located in a different physical location than the sensors in the aircraft and there is generally limited bandwidth available in the communication between the processor and the sensors, it is difficult to send all the recorded samples for a plurality of sensors to the processor for processing. It is thus often advantageous to be able to send fewer samples to the processor.

More particularly, FIGS. 5A, 5B and 5C depict bottom view 500, left side view 550 and right side view 550, respectively, of a helicopter 520 having a plurality of sensor arrays 102 disposed on its fuselage at suitable hull mounting points, according to an illustrative embodiment of the invention. For purposes of clarity, and not by way of limitation, one exemplary placement of sensor arrays 102 in system 100 (FIG. 1) may be described herein in the context of placing the sensors arrays 102 on a helicopter. However, it will be appreciated that the principles described herein may be adapted to other aircraft, ground vehicles, or even one or more buildings. For example, the principles of this disclosure may be applied to airplanes where the sensor arrays are positioned based on the constraints imposed by the physical structure of the airplane, or to Humvees where the sensor arrays are positioned based on constraints imposed by the physical—external or internal—structure. More generally, the systems described herein may be employed as suitable, and accounting for the physical constraints present in any aircraft, ground vehicle, or building where it is desirable to provide shooter detection system 100 (FIG. 1).

The bottom portion 520 of the fuselage of the helicopter 500 includes six (6) sensor arrays 102a-102f positioned from the nose region 524 to the tail region 532. As shown, the region underneath the cockpit 502 includes one sensor array 102a. The region underneath the cabin 528 and the engine/transmission/fuel tank 530 includes three (3) sensor arrays 102b, 102c, and 102d. The bottom of tail boom portion 522 includes two (2) sensor array 102e and 102f. Each of the sensor arrays includes at least two sensors. In general, the number of sensors in each sensor array may range from two (2) to eight (8). In the arrangement of sensor arrays, at least two sensor arrays may be at least 10m apart. For example, the sensor arrays 102a or 102b under the nose region 524 may be separated from sensor array 102f under the tail boom 532 by a distance of greater than about 10 m. One or more physical constraints such as the location of hull mounting points or the internal wiring access points in the helicopter found on the bottom of the helicopter 520 may influence the placement of the sensor arrays 102a-102g. In certain embodiments, the bottom 500 of helicopter 520 includes landing gear such as skids or wheel-bays. The sensor arrays 102a-102f may be suitably placed around these physical constraints. In certain embodiments, the sensor arrays are placed at suitable hull mounting points on the fuselage of the helicopter 520. In certain embodiments, the sensor arrays 102a-102f may be placed on the skids.

The top and side portions 550 and 570 of the fuselage of the helicopter 520 include a plurality of sensor arrays 102g-102p positioned from the nose region 524 to the tail region 532. Sensor array 102g is placed below the cockpit 526 of the helicopter 520. Sensor array 102h is placed between the cockpit 526 and cabin 528 of the helicopter 520. Sensory array 102i is placed above the cabin 528 of helicopter 520. Sensor array 102k is placed on the engine/transmission/fuel tank 530 and sensor arrays 102k and 102j are disposed on the tail boom 522. Sensor arrays 102m-102p are similar to sensor arrays 102g-102k and may be placed on the side 570 opposite to side 550 of the helicopter 520. In certain embodiments, sensor array 102g may be placed anywhere on the nose 524 including the front portion. In the arrangement of sensor arrays, at least two sensor arrays may be at least 10m apart. For example, the sensor array 102g below cockpit 526 may be separated from sensor array 102j on the tail boom 522 by a distance of greater than about 10 m. As described above, one or more physical constraints (e.g., location of wiring harnesses in the helicopter 520) found on the front and sides 550 and 570 of the helicopter 520 may influence the placement of the sensor arrays 102g-102p. As an example, the sides of the helicopter 520 may include a plurality of doors, windows and service bays. The sensor arrays 102g-102p may be suitably placed around these physical constraints.

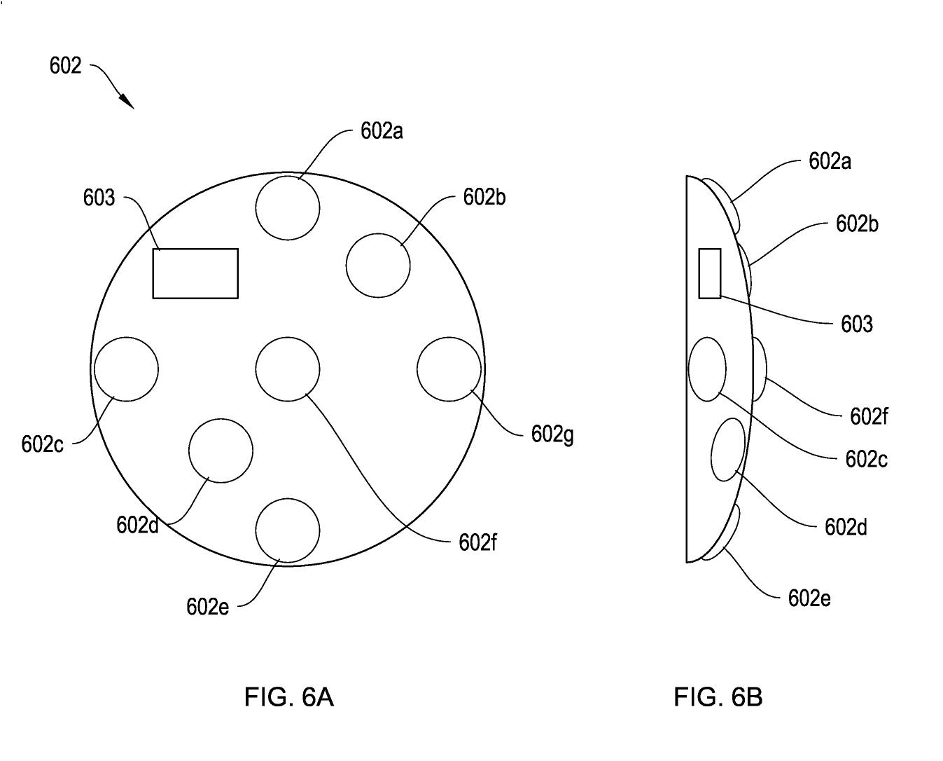

FIGS. 6A and 6B depict top and side views, respectively, of an array 602 of acoustic sensors suitable for use as a sensor array 102 (FIG. 1) in shooter detection system 100 (FIG. 1) of an aircraft, ground vehicle, or building, according to an illustrative embodiment of the invention. For instance, such a sensor array 602 may be placed as shown on helicopter 520 of FIGS. 5A-C. Sensor array 602 includes seven (7) acoustic sensors 602a-602g. In some embodiments, one or more of the sensors is in communication with location processor 104 (FIG. 1). Optionally, the sensor array 602 may include a sensor array processor 603 that communicates with each of the sensors 602a-602g as well as location processor 104 (FIG. 1). In this embodiment, there would be no direct connection between the location processor 104 and the sensors 602a-602g. The communication between the sensor array processor 603, location processor 104 (FIG. 1) and the sensors 602a-602g may occur over any suitable communication link (not shown in FIGS. 6A and 6B), e.g., a wired or wireless link. In aircraft, this link would typically be wired due to the lack of reliability of wireless communication links in aircraft environments which are associated with engine noise and other intense turbulence.

In certain embodiments, the acoustic sensor are microphones. In certain embodiments, the sensor arrays 102 include digital microphones that have delta modulated signal outputs, or analog outputs. In such embodiments, the sensor arrays 102 may include flush-mounted microphones having a diameter of about lcm. In such embodiments the sensor arrays 102 may include fairing-mounted microphones where the fairings may include windscreens and cavities to offset the microphones from air flow.

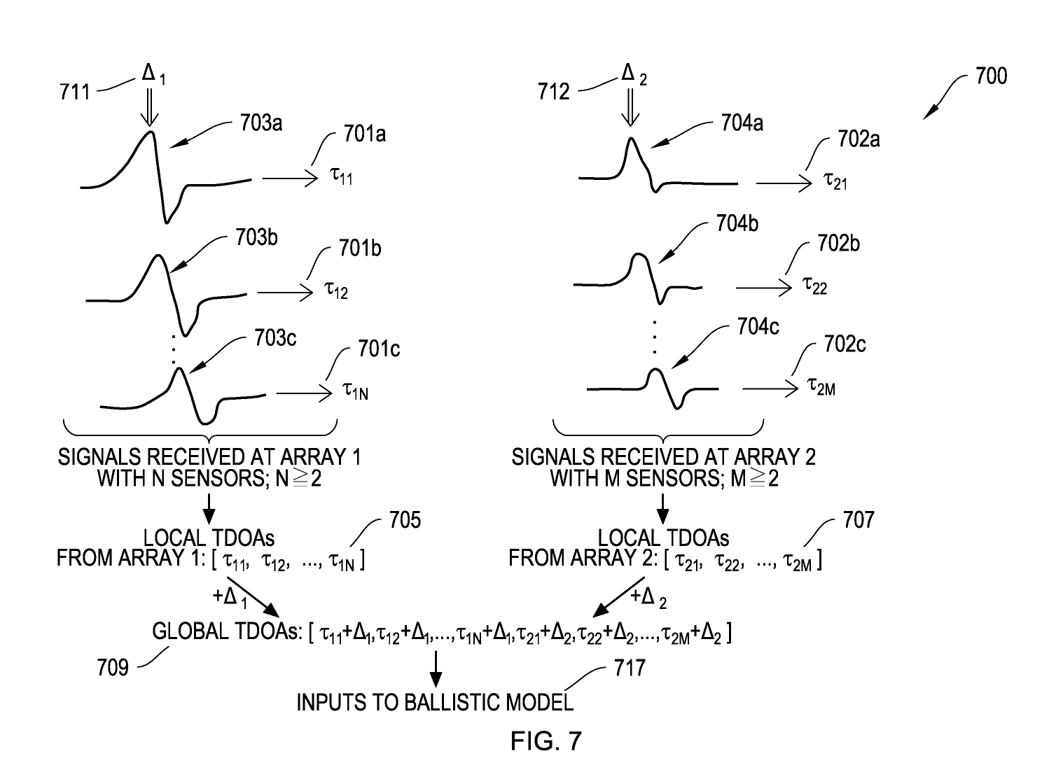

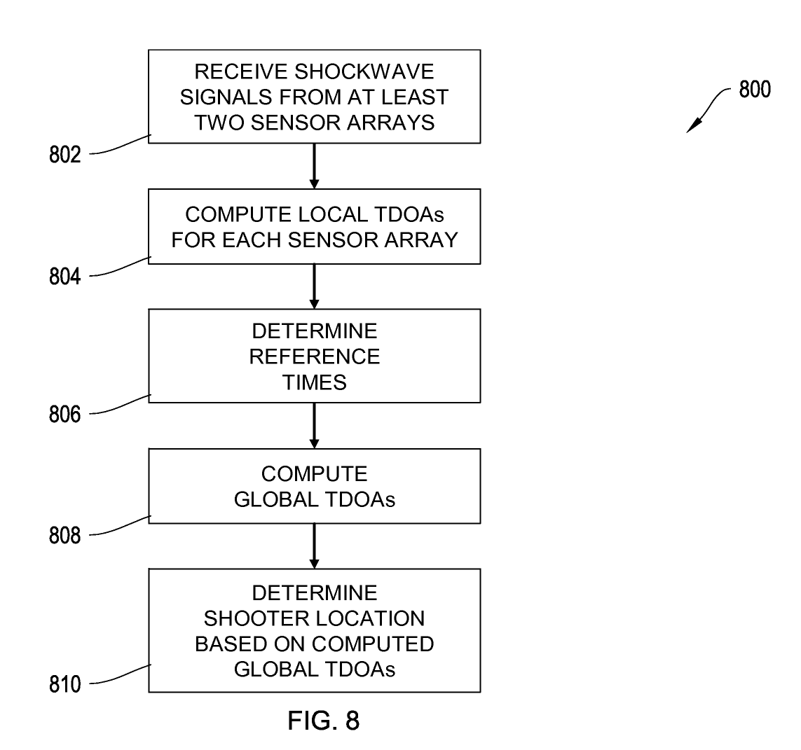

FIG. 7 is a schematic 700 for a process flow for a method for detecting a shooter's location using information received by at least two arrays of acoustic sensors, while FIG. 8 shows a block diagram 800 for this method, according to illustrative embodiments of the invention. The method described in FIGS. 7 and 8 may be performed by location processor 104 (FIG. 1) in an aircraft, building, or ground vehicle. In some embodiments, location processor 104 (FIG. 1) may receive information from the sensor arrays 102 via array processors 103 (FIG. 1) or directly from the sensors in the sensor arrays 102 (FIG. 1). As described above, while the discussion that follows describes embodiments with respect to a shockwave, for embodiments in which muzzle blast signals are detected, the description herein is applicable to synchronizing the timing information associated with these signals. More generally, the sensors arrays 102 may include any suitable sensor, e.g., seismic sensors, acoustic sensors, active sonar sensor arrays, or passive sonar sensor arrays, and the timing information associated with the signals generated by these sensors may be synchronized.

With continued reference to FIGS. 1, 7 and 8, process 800 begins with the sensors of at least two acoustic sensor arrays 102 receiving a shockwave signal (802). Those skilled in the art will come to realize that a muzzle blast signal may be used in addition to or as an alternative to the shockwave signal and the description that follows. These sensor arrays are denoted Array 1 and Array 2. The shockwave signals 703a, 703b, . . . , 703c are generated by a first sensor array (Array 1), while the shockwave signals 704a, 704b, . . . , 704c are generated by a second sensor array (Array 2). Each of the sensor arrays may have different numbers of sensors, but in general, Array 1 includes N sensors where N≧2, while Array 2 includes M sensors where M≧2. For each pair of received shockwave signals, local TDOAs associated with sensors in Array 1, τ₁₁ to τ_{1N} (701a-701c), and local TDOAs associated with the sensors in Array 2, τ₁₁ to τ_{1M} (702a-702c), are computed (804). This computation may be performed by either location processor 104 or array processors 103, and results in local TDOAs 705 and 707.

With continued reference to FIGS. 1, 7 and 8, location processor 104 or array processors 103 then compute a local reference time associated with each of the sensor arrays (806). In some embodiments, the time at which a shockwave signal peak is generated by a first sensor in Array 1 is denoted Δ₁(711), while the time at which a shockwave signal peak is generated by a first sensor in Array 2 is denoted Δ₂ (712), and these times are used as local reference times for Array 1 and Array 2, respectively. Location processor 104 then computes global TDOAs from the local reference times and local TDOAs from each of the sensor arrays (808). In one embodiment, to compute global TDOAs, location processor 104 aligns the local TDOAs with respect to the computed local reference times, e.g., times 711 and 712. In some embodiments, the local reference times 711 and 712 and local TDOAs 705 and 707 are computed by array processors 103 and transmitted to location processor 104 via a suitable communication or data interface.

In alternative embodiments in which a muzzle blast is detected by the sensors arrays 102, location processor 104 or array processors 103 can compute a local reference time associated with each of the sensor arrays using both shockwave and/or muzzle blast information (806). For example, a local time metric such as the difference between the time at which a shockwave signal peak is generated by a first sensor in an array and the time at which a muzzle blast peak is generated by a first sensor in the same array may be used for the array, with one of these times used as the local reference time for the array. Location processor 104 then computes global TDOAs and/or other time metrics from these local time metrics and/or reference times from each of the sensor arrays (808). In one embodiment, to compute global TDOAs, location processor 104 aligns the local time metrics with respect to the computed local reference times, e.g., times 711 and 712. In some embodiments, the local reference times 711 and 712 and local time metrics are computed by array processors 103 and transmitted to location processor 104 via a suitable communication or data interface.

In embodiments in which array processors 103 perform the computation, the clocks in each of the array processors 103 are synchronized relative to a global reference time T. This global reference time T may be the clock time that is employed by location processor 104 in determining global TDOA data. In some embodiments, the location processor 104 may transmit its clock time T to each of the array processors 103 thereby providing a global reference time T to each of the array processors 103 for synchronization. In this manner, location processor 104 can perform computations for global TDOAs based on local reference times and local TDOAs that are synchronized. For instance, the times at which shockwave signal peaks are generated by sensors in Array 1 and Array 2, Δ₁ and Δ₂ in FIG. 7, are local reference times that are relative to this global reference time T.

In some embodiments, location processor 104 computes a relationship between either the local TDOAs or the global TDOAs. This relationship may include an alignment of the local TDOAs with respect to the computed local reference times, as described above. In some embodiments, this relationship includes a cross-correlation between the local TDOAs and/or the global TDOAs. In some embodiments, a cross-correlation of the local TDOAs (“local cross-correlation function”) at a respective sensor array may be computed, and the time corresponding to the peak of this cross-correlation is recorded as the local reference time. This computed local reference time is then used by the location processor 104 to compute global TDOAs as described above. In some embodiments, this local reference time is computed by the sensor array processors 103 and transmitted to the location processor 104, which in turn computes the global TDOAs. In other embodiments, instead of or in addition to local reference times, a global reference time T is used by location processor 104 to compute the global TDOAs.

In some embodiments, samples of the respective local cross-correlation functions are computed by the array processors 103, and these samples, not simply the computed local reference time, are subsequently transmitted to the location processor 104. The location processor 104 then uses these samples to determine global TDOAs.

Those skilled in the art will realize that other “reference times” may be computed, either by the location processor 104 or by the sensor array processors 103, and used to compute global TDOAs and/or determine an unambiguous solution for the shooter location.

With continued reference to FIGS. 1, 7 and 8, location processor 104 then provides the global TDOAs to shooter location application 108. The global TDOAs serve as inputs to a ballistic model 717 which is used by shooter location application 108 to determine an unambiguous shooter location corresponding to the received shockwave signals (810). The ballistic model 717 and its TDOA inputs are described in U.S. Pat. No. 7,359,285, the contents of which are incorporated herein in their entirety.

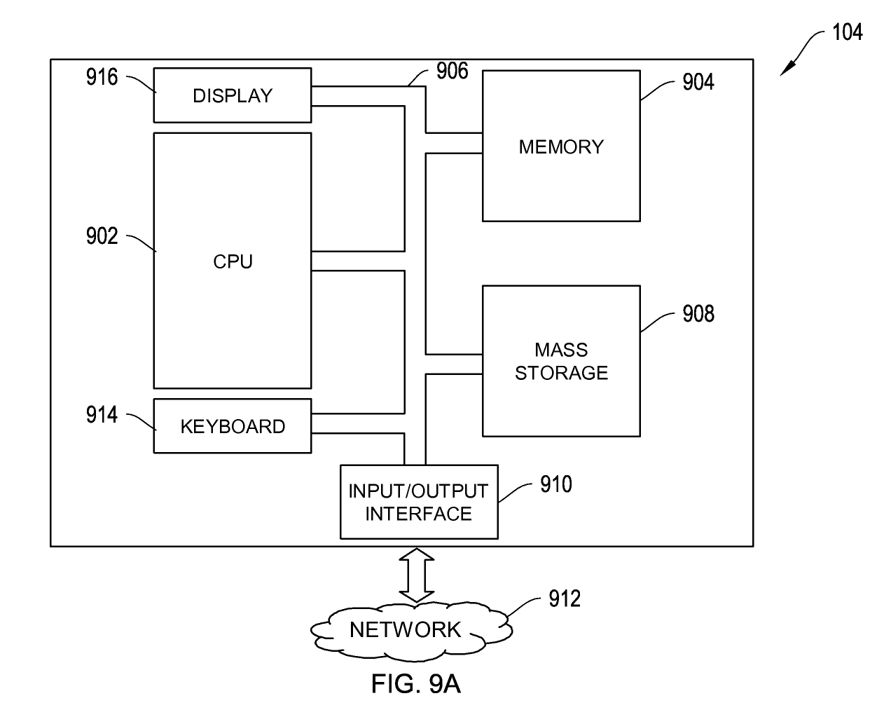

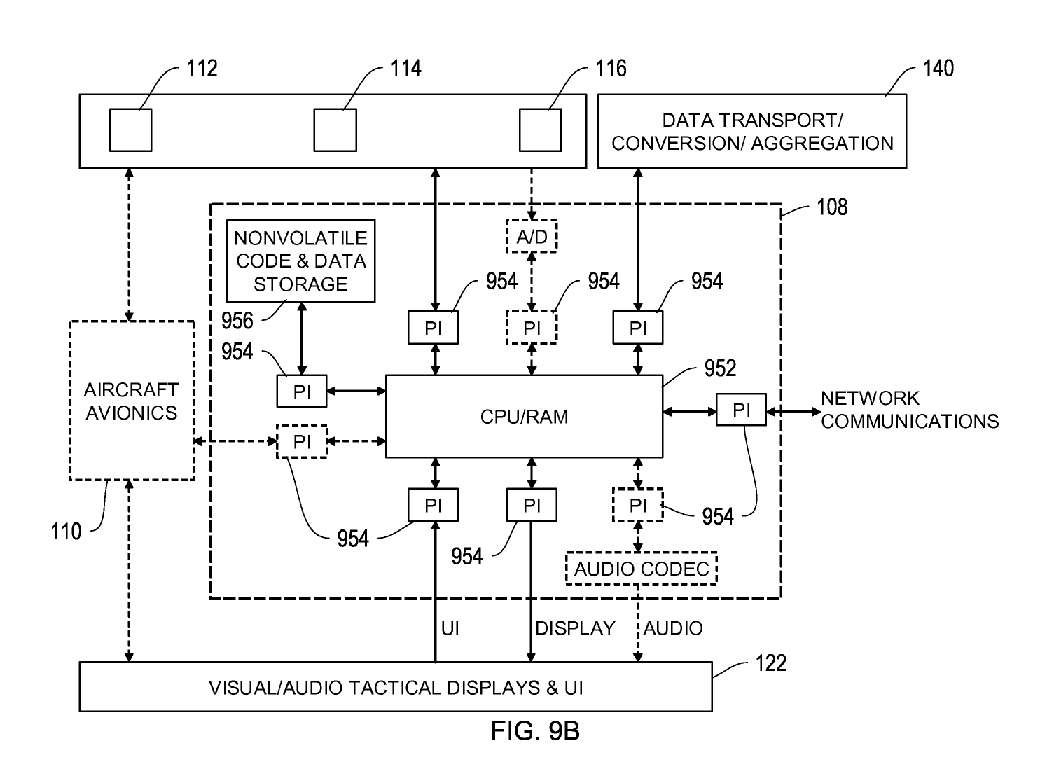

FIG. 9A is a general block diagram depicting the physical components of the location processor 104 of FIG. 1, according to an illustrative embodiment of the invention. Those skilled in the art will realize that each of the sensor array processors 103 may include some or all of the components described in FIG. 9A.

With continued reference to FIGS. 1 and 9A, the exemplary location processor 104 includes a central processing unit (CPU) 902, a memory 904, and an interconnect bus 906. The CPU 902 may include a single microprocessor or a plurality of microprocessors for configuring location processor 104 as a multi-processor system. The memory 904 illustratively includes a main memory and a read only memory. The location processor 104 also includes the mass storage device 908 having, for example, various disk drives, tape drives, FLASH drives, etc. The main memory 904 also includes dynamic random access memory (DRAM) and high-speed cache memory. In operation, the main memory 904 stores at least portions of instructions and data for execution by the CPU 902.

The mass storage 908 may include one or more magnetic disk or tape drives or optical disk drives, for storing data and instructions for use by the CPU 902. At least one component of the mass storage system 908, preferably in the form of a disk drive or tape drive, stores the database used for processing the signals measured by the sensors in the sensor arrays 102 (FIG. 1). The mass storage system 608 may also include one or more drives for various portable media, such as a floppy disk, a compact disc read only memory (CD-ROM), DVD, or an integrated circuit non-volatile memory adapter (i.e. PC-MCIA adapter) to input and output data and code to and from the location processor 104 of FIG. 1.

The location processor 104 of FIG. 1 may also include one or more input/output interfaces for communications, shown by way of example, as interface 910 for data communications via the network 912. The data interface 910 may be a modem, a network card, serial port, bus adapter, or any other suitable data communications mechanism for communicating with one or more systems on-board the aircraft or on the ground. To provide the functions of a location processor 104 according to FIG. 1, the data interface 910 may provide a relatively high-speed link to a network 912, such as on-board avionics intranet, or ground based networks such as the Internet. The communication link to the network 912 may be, for example, optical, wired, or wireless (e.g., via satellite or cellular network). Alternatively, the location processor 104 may include a mainframe or other type of host computer system capable of communications via the network 912. The location processor 104 may communication with each of the sensor arrays 102 (FIG. 1) and/or each of the sensor array processors 103 via data interface 910.

With continued reference to FIGS. 1 and 9A, the location processor 104 also includes suitable input/output ports or use the interconnect bus 906 for interconnection with avionics 110, a local display 916 and keyboard 914 or the like serving as a local user interface for programming and/or data retrieval purposes. Alternatively, personnel may interact with the processor 104 for controlling and/or programming the system from remote terminal devices via the network 912.

The location processor 104 may run a variety of application programs and stores associated data in a database on mass storage system 908. One or more such applications may enable the receipt and delivery of messages to enable operation as a server, for implementing server functions relating to measuring or receiving acoustic signals from sensor arrays 102 or sensor array processors 103, and locating the position of a shooter by system 100 of FIG. 1.

In certain embodiments, the CPU 902 includes circuitry for an analog-to-digital converter and/or a digital-to-analog converter. In such embodiments, the analog-to-digital converter circuitry converts analog signals received at the sensors to digital signals for further processing by the location processor 104.

The components contained in the location processor 104 are those typically found in aircraft computer systems, flight-deck avionics, combat avionics, general purpose computer systems used as servers, workstations, personal computers, network terminals, and the like. In fact, these components are intended to represent a broad category of such computer components that are well known in the art. Certain aspects of the invention may relate to the software elements, such as the executable code and database for the server functions of the detection system 100.

Generally, the methods described herein may be executed on a conventional data processing platform such as an IBM PC-compatible computer running the Windows operating systems, a SUN workstation running a UNIX operating system or another equivalent personal computer or workstation. Alternatively, the data processing system may comprise a dedicated processing system that includes an embedded programmable data processing unit.

The process described herein may also be realized as a software component operating on a conventional data processing system such as a UNIX workstation. In such an embodiment, the process may be implemented as a computer program written in any of several languages well-known to those of ordinary skill in the art, such as (but not limited to) C, C++, FORTRAN, Java or BASIC. The process may also be executed on commonly available clusters of processors, such as Western Scientific Linux clusters, which are able to allow parallel execution of all or some of the steps in the present process.

The method for determining shooter location described herein may be performed in either hardware, software, or any combination thereof, as those terms are currently known in the art. In particular, the present method may be carried out by software, firmware, or microcode operating on a computer or computers of any type, including preexisting or already-installed avionics processing facilities capable of supporting any or all of the location processor's functions. Additionally, software embodying the systems and methods described herein may comprise computer instructions in any form (e.g., source code, object code, interpreted code, etc.) stored in any non-transitory computer-readable medium (e.g., ROM, RAM, magnetic media, punched tape or card, compact disc (CD) in any form, DVD, etc.). Accordingly, the systems and methods described herein are not limited to any particular platform, unless specifically stated otherwise in the present disclosure.

FIG. 9B is a more detailed block diagram depicting the physical components of the computer system of FIG. 9A, according to an illustrative embodiment of the invention. In particular, the location processor 104 includes a CPU/RAM unit 952 and a plurality of integrated and/or attached peripheral interfaces (“PI”) 954. The PI 954 may serve as a communication link between at least two of data transport unit 140, sensors 112, 114 and 116, data storage 956, displays 122 including helmet display, audio units and network communications. The PI 954 may comprise a suitable interface including at least one of a RS232, RS432, RS422 and RS485 serial ports. The PI 954 may also include at least one of universal serial bus (USB), parallel port, I-squared C bus, I-squared S bus, ARINC 429 bus, MIL-STD-1553 bus, Ethernet, LVDS. The PI 954 may also be fully custom designed for a particular application.

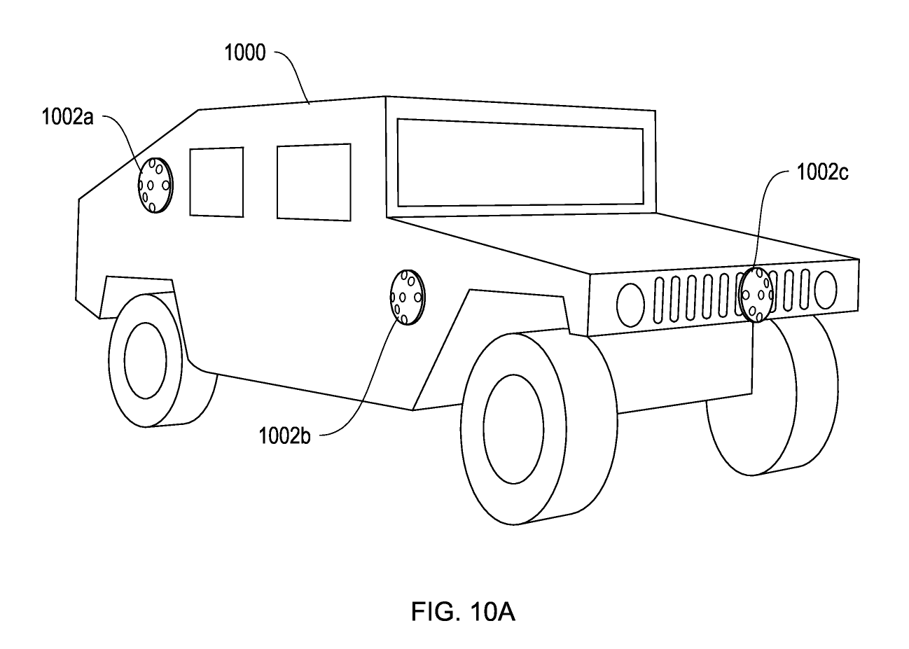

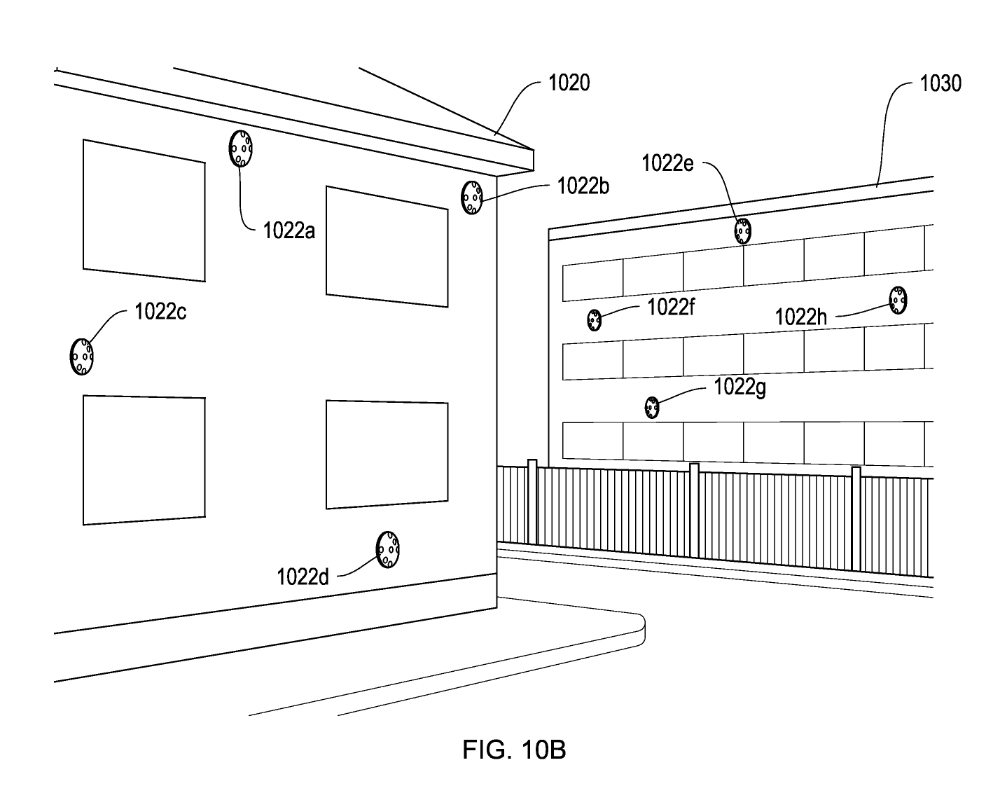

FIG. 10A shows a Humvee 1000, an example of a ground vehicle, according to an illustrative embodiment of the invention. Humvee 1000 includes sensor arrays 1002a, 1002b, and 1002c. Each of these sensor arrays may include a sensor array processor, and include at least two sensors. The sensor arrays 1002a, 1002b, and 1002c are in communication with a location processor (not shown) which performs a method for determining a shooter location associated with a projectile fired at the Humvee 1000. The sensor arrays 1002a, 1002b, and 1002c are mounted on the Humvee at allowable locations such that the distance between these sensors arrays is suitable for disambiguating shooter locations, as described above with respect to FIGS. 1-4, 9A and 9B.

FIG. 10B shows buildings 1020 and 1030, according to an illustrative embodiment of the invention. Buildings 1020 and 1030 include sensor arrays 1022a, 1022b, 1022c, 1022d, 1022e, 1022f, 1022g, and 1022h. Each of the sensor arrays 1022a-h may include a sensor array processor, and each of the sensor arrays 1022a-h include at least two sensors. The sensor arrays 1002a-h are in communication with a location processor (not shown) which performs a method for determining a shooter location associated with a projectile fired at or near either of the buildings 1020 and 1030. The sensor arrays 1022a-h are mounted on the buildings at allowable locations such that the distance between these sensors arrays is suitable for disambiguating shooter locations, as described above with respect to FIGS. 1-4, 9A and 9B.

The invention may be embodied in other specific forms without departing from the spirit or essential characteristics thereof. The forgoing embodiments are therefore to be considered in all respects illustrative, rather than limiting of the invention. For instance, the systems and methods described herein may be applied to a ground vehicle or a building as shown in FIGS. 10A and 10B.

What is claimed is:

1. A shooter detection system, comprising:
at least two arrays of sensors, each including at least two sensors, spaced apart on the surface of a body, the sensors configured for receiving signals indicative of timing information associated with a shockwave of a projectile;
a location processor coupled to each of the at least two arrays of sensors configured for unambiguously determining the location of the source of the projectile based on signals output by each of the at least two arrays of sensors; and
an output device in communication with the location processor for outputting the determined shooter location.

2. The system of claim 1, wherein the body is one of an aircraft, a ground vehicle, and a building.

3. The system of claim 1, wherein at least two arrays of sensors are separated by a distance sufficient to unambiguously determine the location with a probability of greater than about 0.8.

4. The system of claim 1, wherein determining the location of the source of the projectile includes:
computing local Time Differences Of Arrival (TDOAs) associated with each of the at least two arrays of sensors;
determining local reference times associated with each of the at least two arrays of sensors;
computing global TDOAs based on local Time Differences Of Arrival (TDOAs) associated with each of the at least two arrays of sensors and local reference times associated with each of the at least two arrays of sensors; and
determining the shooter location based on a relationship between the computed global TDOAs.

5. The system of claim 4, wherein the relationship comprises a correlation between the global TDOAs.

6. The system of claim 5, wherein computing global TDOAs comprises substantially aligning the received signals with respect to the local reference times at each of the at least two arrays of sensors.

7. The system of claim 1, further comprising
a first array processor in communication with a first array of sensors of the at least two arrays of the sensors for
computing local Time Differences Of Arrival (TDOAs) from the signals received at the first array of sensors; and
transmitting the computed local TDOAs associated with the first array of sensors to the location processor for use in determining the shooter location.

8. The system of claim 1, further comprising
a second array processor in communication with a second array of the at least two arrays of the sensors for
computing local Time Differences Of Arrival (TDOAs) from the signals received at the second array of sensors; and
transmitting the computed local TDOAs associated with the second array of sensors to the location processor for use in determining the shooter location.

9. The system of claim 1, wherein each array of sensors includes at least two sensors mounted to a sensor mount, and wherein the sensor mount is attached to the surface of the body.

10. The system of claim 9, wherein the sensor mount includes an array processor.

11. A method for locating a shooter of a projectile fired at a body, comprising:
receiving, from at least two arrays of sensors mounted on the surface of the body, each array including at least two sensors, signals indicative of timing information associated with a shockwave of a projectile fired at the body;
analyzing the signals received at the at least two arrays of sensors to unambiguously determine a location of the shooter of the projectile, wherein analyzing includes
computing, by a location processor, global Time Differences Of Arrival (TDOAs) associated with each of the at least two arrays of sensors and local reference times associated with each of the at least two arrays of sensors; and
determining, by the location processor, the shooter location based on a relationship between the computed global TDOAs; and
outputting, by the location processor, the location of the shooter to an output device.

12. The method of claim 11, wherein the body is one of an aircraft, a ground vehicle, and a building.

13. The method of claim 11, wherein analyzing the signals further includes
computing, by the location processor, local Time Differences Of Arrival (TDOAs) associated with each of the at least two arrays of sensors; and
determining, by the location processor, local reference times associated with each of the at least two arrays of sensors, and wherein computing global TDOAs is based at least in part on the computed local Time Differences Of Arrival (TDOAs).

14. The method of claim 11, wherein the relationship comprises a correlation between the global TDOAs.

15. The method of claim 11, wherein computing global TDOAs comprises the location processor substantially aligning the received signals with respect to the local reference times at each of the at least two arrays of sensors.

16. The method of claim 11, wherein analyzing the signals further includes
computing, by a first array processor in communication with the sensors in a first array of sensors of the at least two arrays of the sensors and the location processor, local Time Differences Of Arrival (TDOAs) of shockwave signals detected by the sensors in the first array of sensors; and
transmitting, by the first array processor, the computed local TDOAs associated with the first array of sensors to the location processor for use in determining the shooter location.

17. The method of claim 11, wherein analyzing the signals further includes
computing, by a second array processor in communication with a second array of sensors of the at least two arrays of the sensors and the location processor, local Time Differences Of Arrival (TDOAs) associated with the second array of sensors; and
transmitting, by the second array processor, the computed local TDOAs associated with the second array of sensors to the location processor.

18. A non-transitory computer readable medium including computer readable instructions which, when executed by a processor, cause the processor to perform a method including:
receiving signals indicative of timing information associated with a shockwave of a projectile fired at the body from at least two arrays of sensors mounted on the surface of a body, each array including at least two sensors;
computing global Time Differences Of Arrival (TDOAs) associated with each of the at least two arrays of sensors and local reference times associated with each of the at least two arrays of sensors; and
determining the shooter location based on a relationship between the computed global TDOAs; and
outputting the location of the shooter to an output device.

19. The computer readable medium of claim 18, wherein the method further includes
computing local Time Differences Of Arrival (TDOAs) associated with each of the at least two arrays of sensors; and
determining local reference times associated with each of the at least two arrays of sensors, and wherein computing global TDOAs is based at least in part on the computed local TDOAs.

20. The computer readable medium of claim 18, wherein the relationship comprises a correlation between the global TDOAs.

21. The computer readable medium of claim 18, wherein computing global TDOAs comprises substantially aligning the received signals with respect to the local reference times at each of the at least two arrays of sensors.

22. A method for synchronizing timing information associated with signals received from at least two sources, comprising:
receiving signals indicative of timing information from the at least two sources;
computing global time metrics associated with each of the at least two sources and local reference times associated with each of the at least two sources; and
determining a relationship between the computed global time metrics.

23. The method of claim 22, wherein the method further includes
computing local time metrics associated with each of the at least two sources; and
determining local reference times associated with each of the at least two sources, and wherein computing global time metrics is based at least in part on the computed local time metrics.

24. The method of claim 22, wherein the relationship comprises a correlation between the global time metrics.

25. The method of claim 22, wherein computing global time metrics comprises substantially aligning the received signals with respect to the local reference times at each of the at least two sources.

26. The method of claim 22, wherein the at least two sources each include at least one array of sensors.

27. The method of claim 22, wherein the at least two sources include one of an acoustic sensor, a seismic sensor, an array of passive sonar sensors, and an array of active sonar sensors.

28. The method of claim 22, wherein the global time metrics include global Time Differences of Arrival (TDOAs).

29. The method of claim 22, wherein the local time metrics include local Time Differences of Arrival (TDOAs).

30. The method of claim 22, wherein the timing information is associated with a shockwave of a projectile.

31. The method of claim 22, wherein the timing information is associated with a muzzle blast of a projectile.
